(19) United States
(12) Patent Application Publication
(10) Pub. No.: US 2014/0167885 A1
(43) Pub. Date: Jun. 19, 2014

(54) BAND-PASS FILTER WITH A LOOP CONFIGURATION

(71) Applicant: MICROELECTRONICS TECHNOLOGY, INC., Hsinchu (TW)

(72) Inventor: CHUNG JUI WANG, HSINCHU (TW)

(73) Assignee: MICROELECTRONICS TECHNOLOGY, INC., HSINCHU (TW)

(21) Appl. No.: 13/720,309

(22) Filed: Dec. 19, 2012

(51) Int. Cl. H01P 1/212

(52) U.S. Cl. CPC H01P 1/212
USPC 333/204

(57) ABSTRACT

A band-pass filter with a loop configuration is implemented on a circuit board in the form of a microstrip line for signals in the gigahertz range. The band-pass filter includes a dielectric substrate and a conductive layer disposed over the dielectric substrate, wherein the conductive layer comprises a loop portion; a first signal terminal extending from a first side of the loop portion; a second signal terminal extending from a second side of the loop portion; a first branch extending from a third side of the loop portion; and a second branch extending from a fourth side of the loop portion.

### BACKGROUND

1. Technical Field

The present invention relates to a band-pass filter, and more particularly, to a band-pass filter with a loop configuration implemented on a circuit board in the form of a microstrip line for signals in the gigahertz range.

2. Description of Related Arts

Band-pass filters have numerous applications in communications and electronics. In wireless communications, a given frequency band must accommodate many wireless users. To accommodate so many users, stringent band-pass filtering requirements must be followed because of the crowded frequency allocations that are provided.

In a modern communication device, a band-pass filter is an essential component for reducing unnecessary emissions of harmonics and parasitic signals from a transmitter, or for enhancing the noise elimination capability of a receiver when receiving signals. Generally, the operation frequency of modern communication devices is rapidly increasing and can be observed in current advancements. For example, the operation frequency for the Long Term Evolution (LTE), marketed as 4G LTE, standard for wireless communication of high-speed data for mobile phones and data terminals has risen up to 37.5 GHz. Therefore, it is an economical and practical approach to implement the band-pass filter on a dielectric substrate in the form of a transmission line, which has in fact been applied to wireless communication devices operating in a millimeter waveband.

### SUMMARY

One aspect of the present disclosure provides a band-pass filter with a loop configuration implemented on a circuit board in the form of a microstrip line for signals in the gigahertz range.

A band-pass filter according to this aspect of the present disclosure comprises a dielectric substrate and a conductive layer disposed over the dielectric substrate. In one embodiment of the present invention, the conductive layer comprises a loop portion, a first signal terminal extending from a first side of the loop portion, a second signal terminal extending from a second side of the loop portion, a first branch extending from a third side of the loop portion, and a second branch extending from a fourth side of the loop portion.

In another embodiment of the present invention, the conductive layer comprises a loop portion, a pair of signal terminals extending from two opposite sides of the loop portion, and a pair of branches extending from two opposite sides of the loop portion, wherein the signal terminals and the branches extend from different sides of the loop portion.

The foregoing has outlined rather broadly the features and technical advantages of the present disclosure in order that the detailed description of the disclosure that follows may be better understood. Additional features and advantages of the disclosure will be described hereinafter, which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures, and:

FIG. 1 is a full view of a band-pass filter according to one embodiment of the present invention;

FIG. 2 is a simulated frequency response diagram of the band-pass filter shown in FIG. 1;

FIG. 3 is a measured frequency response diagram of the band-pass filter shown in FIG. 1;

FIG. 4 is a full view of a band-pass filter according to another embodiment of the present invention;

FIG. 5 is a simulated frequency response diagram of the band-pass filter shown in FIG. 4;

FIG. 6 is a measured frequency response diagram of the band-pass filter shown in FIG. 4;

FIG. 7 is a full view of a band-pass filter according to a further embodiment of the present invention;

FIG. 8 is a simulated frequency response diagram of the band-pass filter shown in FIG. 7;

FIG. 9 is a full view of a band-pass filter according to a further embodiment of the present invention; and

FIG. 10 is a simulated frequency response diagram of the band-pass filter shown in FIG. 9.

### DETAILED DESCRIPTION

The following description of the disclosure accompanies drawings, which are incorporated in and constitute a part of this specification, and illustrate embodiments of the disclosure, but the disclosure is not limited to the embodiments. In addition, the following embodiments can be properly integrated to complete another embodiment.

References to “one embodiment,” “an embodiment,” “exemplary embodiment,” “other embodiments,” “another embodiment,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may.

The present disclosure is directed to a band-pass filter with a loop configuration, which can be implemented on a circuit board in the form of a microstrip line for signals in the gigahertz range. In order to make the present disclosure completely comprehensible, detailed steps and structures are provided in the following description. Obviously, implementation of the present disclosure does not limit special details known by persons skilled in the art. In addition, known structures and steps are not described in detail, so as not to limit the present disclosure unnecessarily. Preferred embodiments of the present disclosure will be described below in detail. However, in addition to the detailed description, the present disclosure may also be widely implemented in other embodiments. The scope of the present disclosure is not limited to the detailed description, and is defined by the claims.

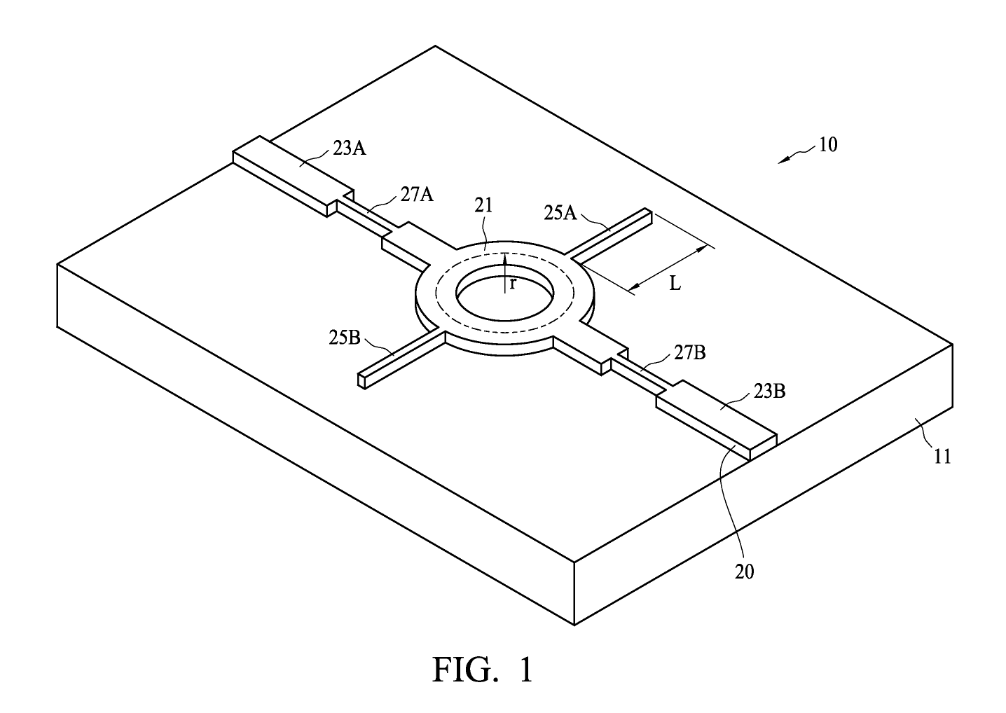

FIG. 1 is a full view of a band-pass filter 10 according to one embodiment of the present invention. In an exemplary embodiment of the present invention, the band-pass filter 10 comprises a dielectric substrate 11 and a conductive layer 20 disposed over the dielectric substrate 11, wherein the conductive layer 20 comprises a circular loop portion 21; a first signal terminal 23A extending from a first side of the loop portion 21;

a second signal terminal 23B extending from a second side of the loop portion 21; a first branch 25A extending from a third side of the loop portion 21; and a second branch 25B extending from a fourth side of the loop portion 21.

In one embodiment of the present invention, the second side is substantially opposite to the first side, and the third side and fourth side are substantially perpendicular to the first side. In one embodiment of the present invention, the first branch 25A is symmetrical to the second branch 25B, and the first branch 25A and the second branch 25B are used for a signal cutoff. In one embodiment of the present invention, the first signal terminal 23A is symmetrical to the second signal terminal 23B, and the first signal terminal 23A and the second signal terminal 23B are used for a signal input and output.

In one embodiment of the present invention, the conductive layer 20 further comprises a first impedance-matching portion 27A connecting the loop portion 21 and the first signal terminal 23A, and a second impedance-matching portion 27B connecting the loop portion 21 and the second signal terminal 23B. In one embodiment of the present invention, the width of the branches 25A and 25B is smaller than the width of the loop portion 21, and the width of the impedance-matching portions 27A and 27B is smaller than the width of the loop portion 21.

In one embodiment of the present invention, the dielectric substrate 11 is an RF-35A2 fiberglass substrate with a dielectric constant of 3.5, and the conductive layer 20 is made of copper. In an exemplary embodiment of the present invention, the characteristic impedance of the signal terminals 23A and 23B is set to a predetermined value; for example, 50 ohms. In an exemplary embodiment of the present invention, the radius (r) of the circular loop portion 21 and the length (L) of the branches 25A and 25B substantially comply with the following formula:

$${λ}_{0} = \frac{C \text{/} {f}_{0}}{\sqrt{{ɛ}_{r}}} , \\ r = \frac{{λ}_{0}}{2 π}$$

$${λ}_{c} = \frac{C \text{/} {f}_{c}}{\sqrt{{ɛ}_{γ}}}$$

$$L = \frac{{λ}_{c}}{4}$$

C represents the velocity of light, f₀ represents a pass band center frequency, f_{c} represents a rejection frequency, λ₀ represents a pass band propagation wave length, λ_{c} represents a rejection band propagation wave length, and εᵣ represents the dielectric constant of the dielectric substrate 11.

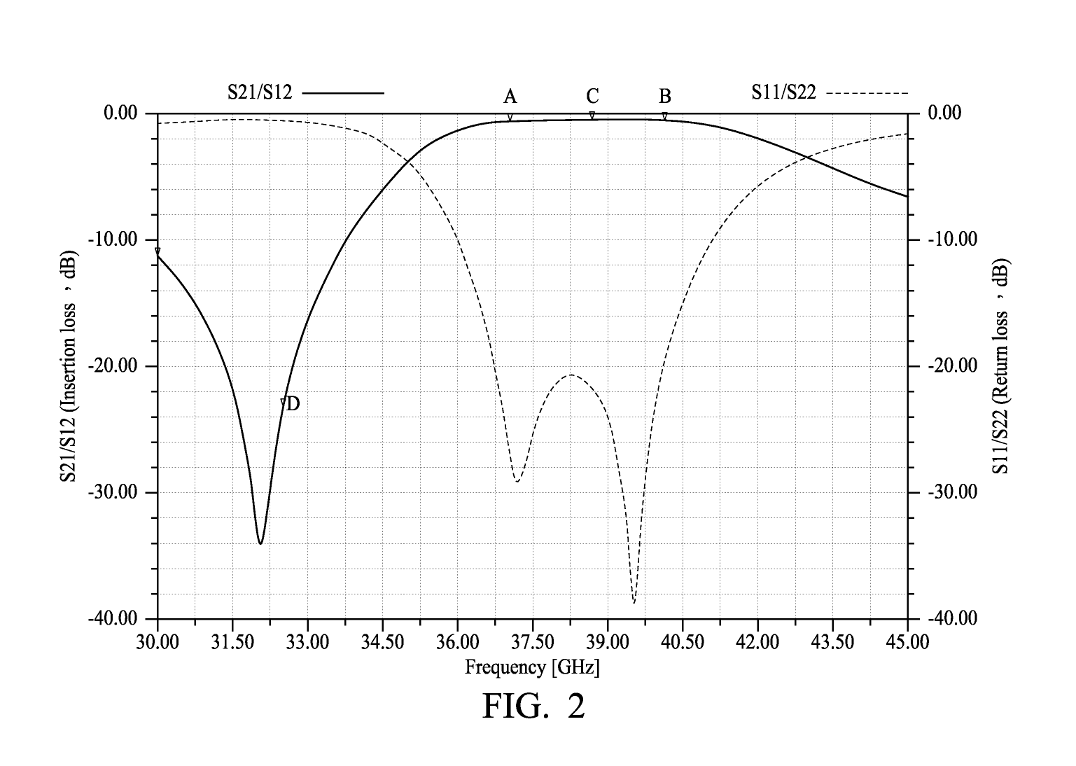

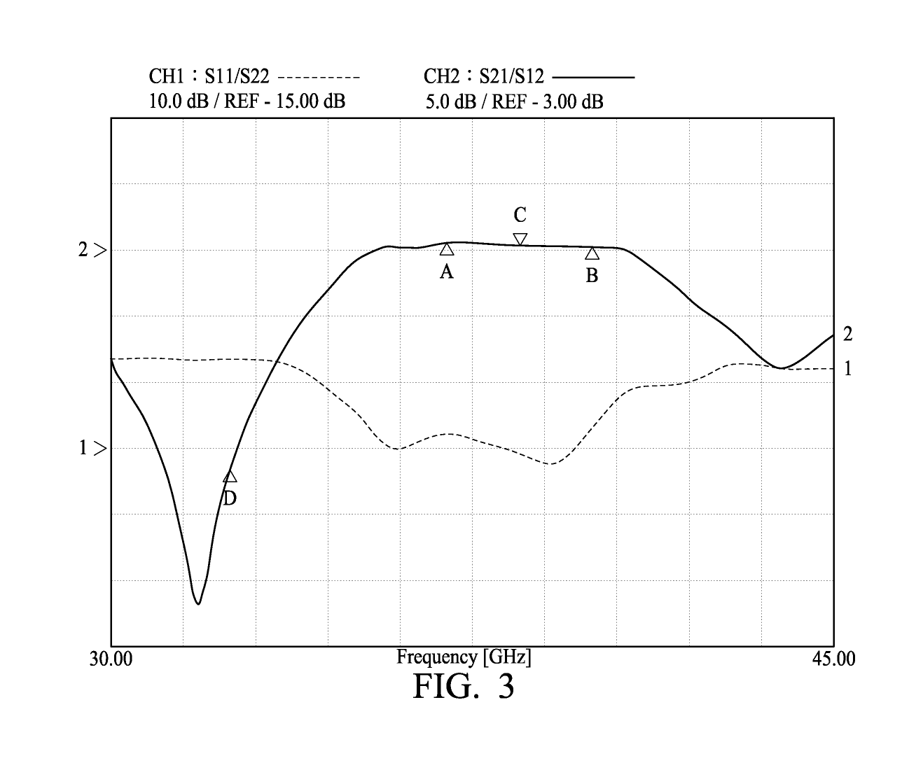

FIG. 2 is a simulated frequency response diagram of the band-pass filter 10, as shown in FIG. 1, and FIG. 3 is a measured frequency response diagram of the band-pass filter 10, as shown in FIG. 1, in which the transverse axis represents the frequency and the longitudinal axis represents the insertion loss (solid line) or return loss (dash line). Comparing FIG. 2 and FIG. 3, it is clear that the simulated frequency response diagram is substantially the same as that of the measured frequency response diagram. As shown in FIG. 3, the pass-band of the band-pass filter 10 is roughly located between 37.0 GHz (point A) and 40.0 GHz (point B) with a center frequency designed to be 38.5 GHz (point C). In addition, the rejection frequency of the band-pass filter 10 is roughly located at 32.5 GHz (point D). Thus, the frequency response characteristic of the band-pass filter 10 adequately meets the requirements of the LTE standard for wireless communication of high-speed data for mobile phones and data terminals.

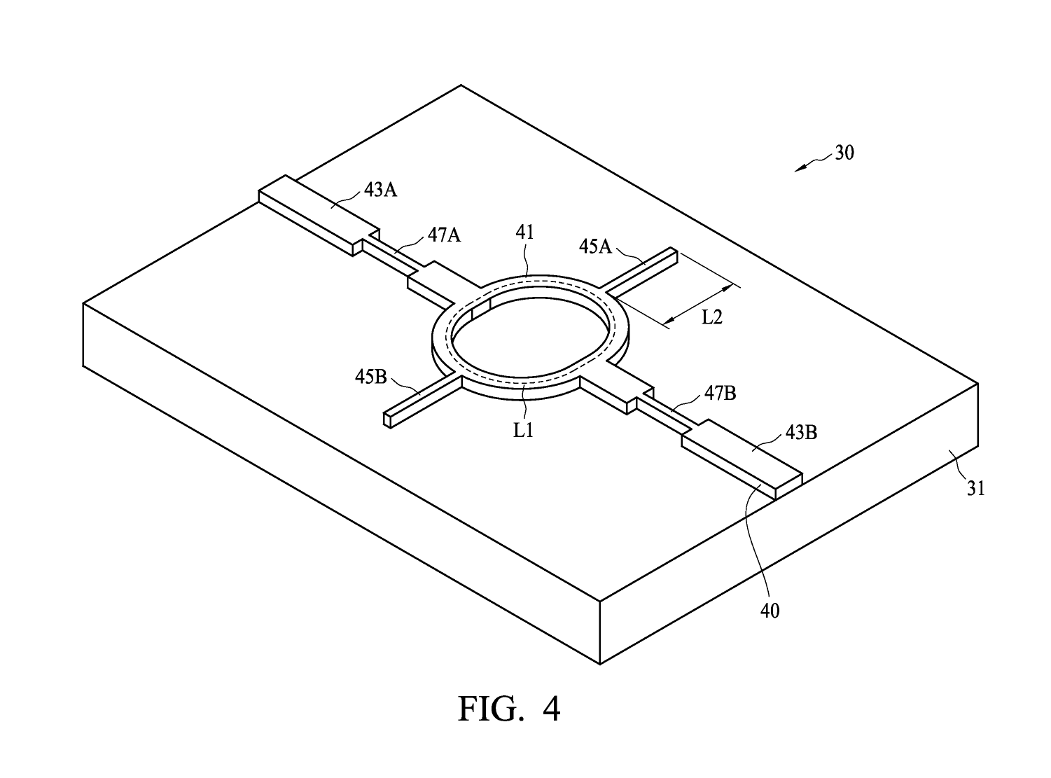

FIG. 4 is a full view of a band-pass filter 30 according to another embodiment of the present invention. In an exemplary embodiment of the present invention, the band-pass filter 30 comprises a dielectric substrate 31 and a conductive layer 40 disposed over the dielectric substrate 31, wherein the conductive layer 40 comprises an elliptic loop portion 41; a first signal terminal 43A extending from a first side of the loop portion 41; a second signal terminal 43B extending from a second side of the loop portion 41; a first branch 45A extending from a third side of the loop portion 41; and a second branch 45B extending from a fourth side of the loop portion 41.

In one embodiment of the present invention, the second side is substantially opposite to the first side, and the third side and fourth side are substantially perpendicular to the first side. In one embodiment of the present invention, and the first branch 45A is symmetrical to the second branch 45B, and the first branch 45A and the second branch 45B are used for a signal cutoff. In one embodiment of the present invention, the first signal terminal 43A is symmetrical to the second signal terminal 43B, and the first signal terminal 43A and the second signal terminal 43B are used for a signal input and output.

In one embodiment of the present invention, the conductive layer 40 further comprises a first impedance-matching portion 47A connecting the loop portion 41 and the first signal terminal 43A, and a second impedance-matching portion 47B connecting the loop portion 41 and the second signal terminal 43B. In one embodiment of the present invention, the width of the branches 45A and 45B is smaller than the width of the loop portion 41, and the width of the impedance-matching portions 47A and 47B is smaller than the width of the loop portion 41.

In one embodiment of the present invention, the dielectric substrate 31 is an RF-35A2 fiberglass substrate with a dielectric constant of 3.5, and the conductive layer 40 is made of copper. In an exemplary embodiment of the present invention, the characteristic impedance of the signal terminals 43A and 43B is set to a predetermined value; for example, 50 ohms. In an exemplary embodiment of the present invention, the length (L1) of the elliptic loop portion 41 and the length (L2) of the branches 45A and 45B substantially comply with the following formula:

$$L 1 = \frac{C \text{/} {f}_{0}}{\sqrt{{ɛ}_{r}}}$$

$${λ}_{c} = \frac{C \text{/} {f}_{c}}{\sqrt{{ɛ}_{γ}}}$$

$$L 2 = \frac{{λ}_{c}}{4}$$

C represents the velocity of light, f₀ represents a pass band center frequency, f_{c} represents a rejection frequency, λ_{c} represents a rejection band propagation wave length, and εᵣ represents the dielectric constant of the dielectric substrate 31.

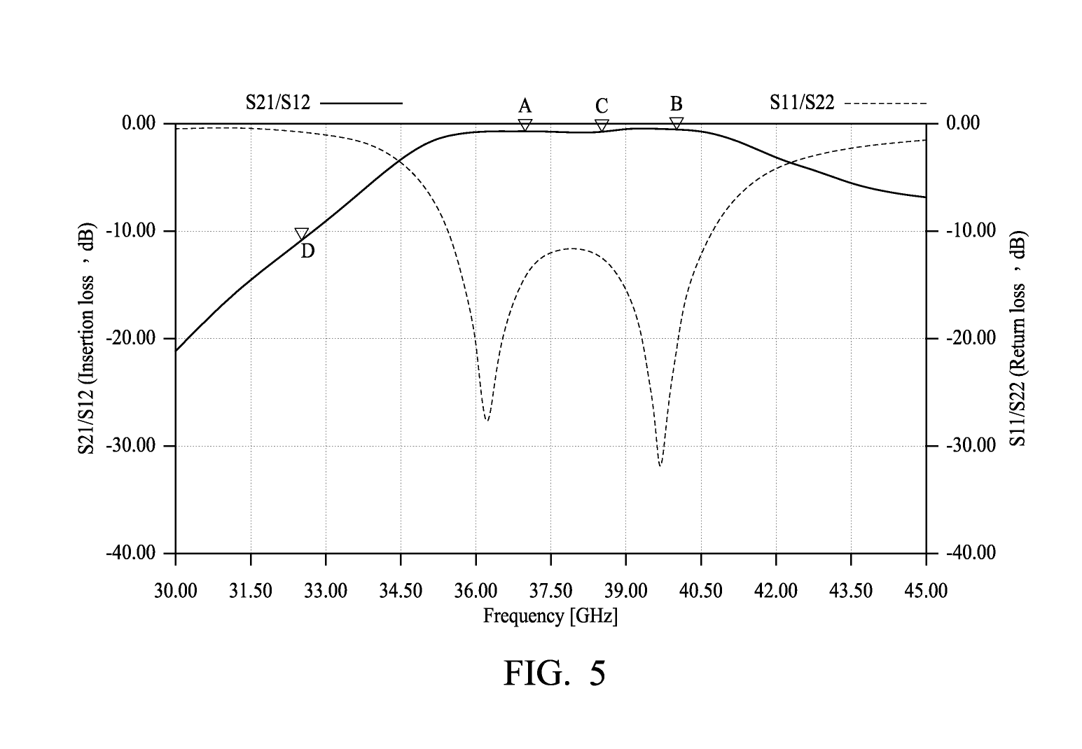

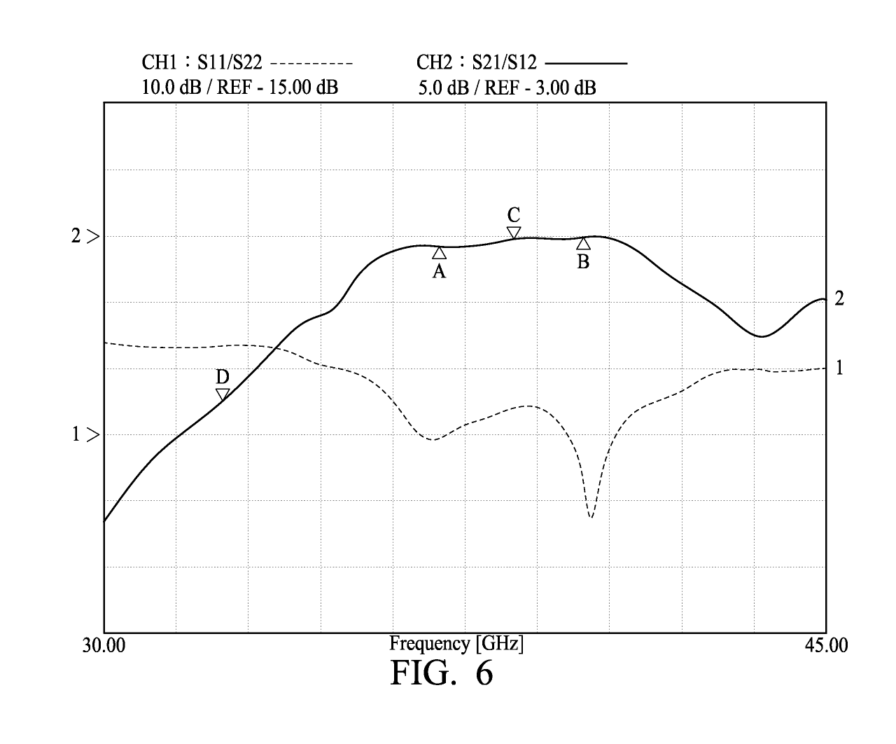

FIG. 5 is a simulated frequency response diagram of the band-pass filter 30, as shown in FIG. 4, and FIG. 6 is a measured frequency response diagram of the band-pass filter 30, as shown in FIG. 4, in which the transverse axis represents the frequency and the longitudinal axis represents the insertion loss (solid line) or return loss (dash line). Comparing FIG. 5 and FIG. 6, it is clear that the simulated frequency response diagram is substantially the same as that of the measured frequency response diagram. As shown in FIG. 5, the pass-band of the band-pass filter 30 is roughly located between 37.0 GHz (point A) and 40.0 GHz (point B) with a center frequency designed to be 38.5 GHz (point C). In addition, the rejection frequency the band-pass filter 30 is roughly located at 32.5 GHz (point D). Thus, the frequency response characteristic of the band-pass filter 30 adequately meets the requirements of the LTE standard for wireless communication of high-speed data for mobile phones and data terminals.

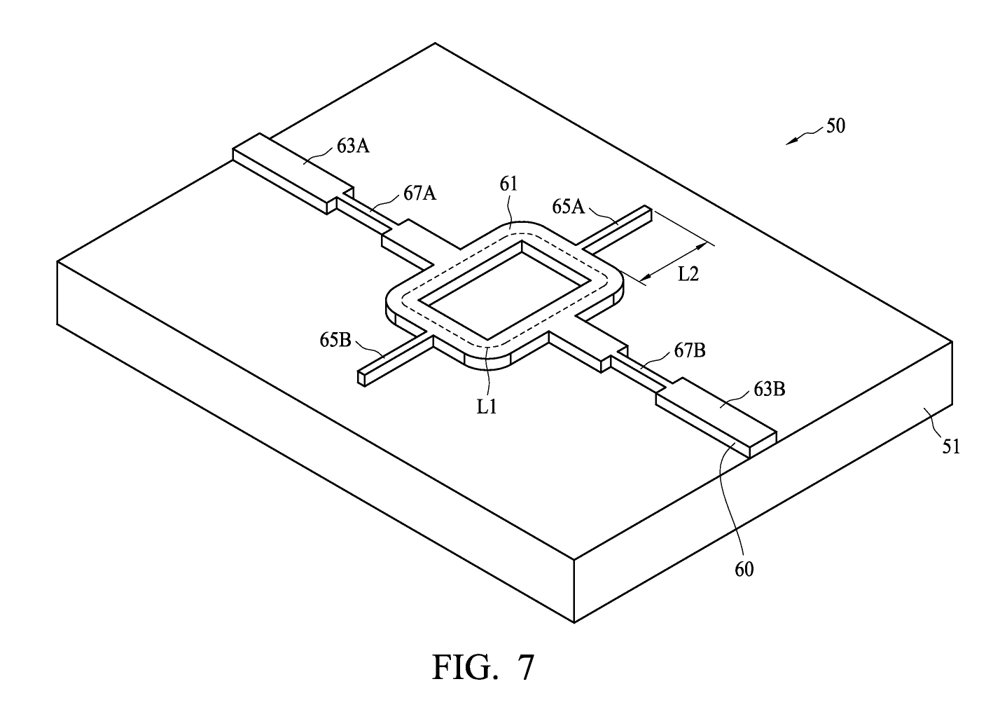

FIG. 7 is a full view of a band-pass filter 50 according to a further embodiment of the present invention. In an exemplary embodiment of the present invention, the band-pass filter 50 comprises a dielectric substrate 51 and a conductive layer 60 disposed over the dielectric substrate 51, wherein the conductive layer 60 comprises a rectangular loop portion 61; a first signal terminal 63A extending from a first side of the loop portion 61; a second signal terminal 63B extending from a second side of the loop portion 61; a first branch 65A extending from a third side of the loop portion 61; and a second branch 65B extending from a fourth side of the loop portion 61.

In one embodiment of the present invention, the second side is substantially opposite to the first side, and the third side and fourth side are substantially perpendicular to the first side. In one embodiment of the present invention, and the first branch 65A is symmetrical to the second branch 65B, and the first branch 65A and the second branch 65B are used for a signal cutoff. In one embodiment of the present invention, the first signal terminal 63A is symmetrical to the second signal terminal 63B, and the first signal terminal 63A and the second signal terminal 63B are used for a signal input and output.

In one embodiment of the present invention, the conductive layer 60 further comprises a first impedance-matching portion 67A connecting the loop portion 61 and the first signal terminal 63A, and a second impedance-matching portion 67B connecting the loop portion 61 and the second signal terminal 63B. In one embodiment of the present invention, the width of the branches 65A and 65B is smaller than the width of the loop portion 61, and the width of the impedance-matching portions 67A and 67B is smaller than the width of the loop portion 61.

In one embodiment of the present invention, the dielectric substrate 11 is an RF-35A2 fiberglass substrate with a dielectric constant of 3.5, and the conductive layer 60 is made of copper. In an exemplary embodiment of the present invention, the characteristic impedance of the signal terminals 63A and 63B is set to a predetermined value; for example, 50 ohms. In an exemplary embodiment of the present invention, the length (L1) of the rectangular loop portion 61 and the length (L2) of the branches 65A and 65B substantially comply with the following formula:

$$L 1 = \frac{C \text{/} {f}_{0}}{\sqrt{{ɛ}_{r}}}$$

$${λ}_{c} = \frac{C \text{/} {f}_{c}}{\sqrt{{ɛ}_{γ}}}$$

$$L 2 = \frac{{λ}_{c}}{4}$$

C represents the velocity of light, f₀ represents a pass band center frequency, f_{c} represents a rejection frequency, λ_{c} represents a rejection band propagation wave length, and εᵣ represents the dielectric constant of the dielectric substrate 51.

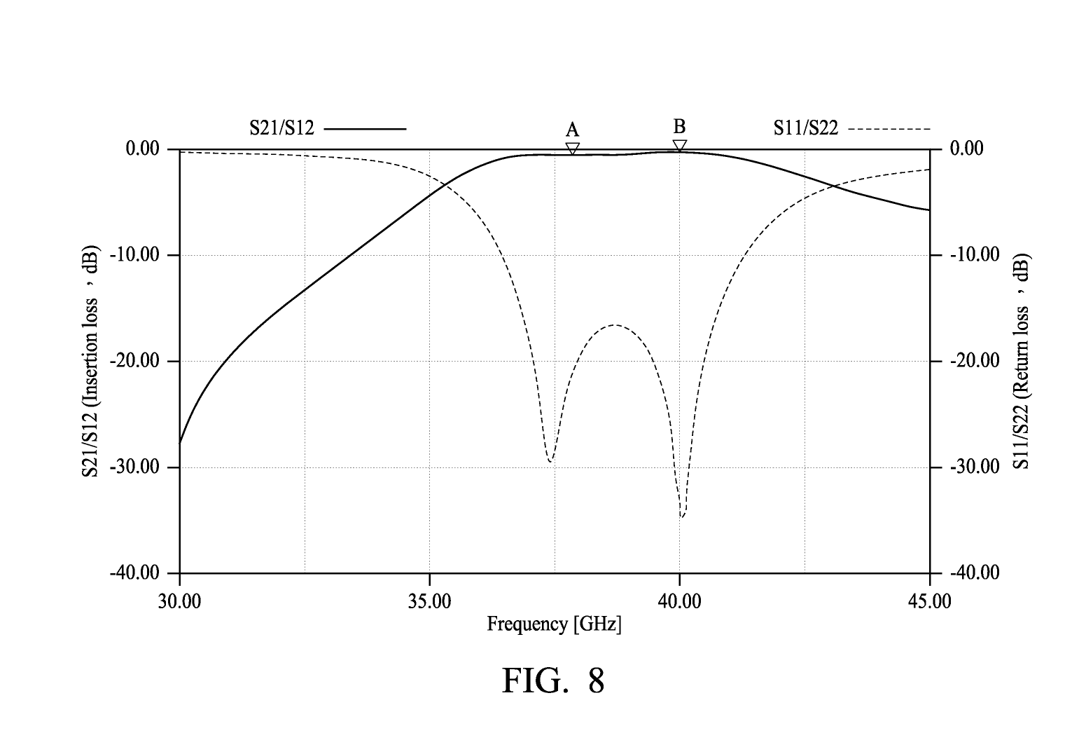

FIG. 8 is a simulated frequency response diagram of the band-pass filter 50, as shown in FIG. 7, in which the transverse axis represents the frequency and the longitudinal axis represents the insertion loss (solid line) or return loss (dash line). As shown in FIG. 8, the pass-band of the band-pass filter 50 is roughly located between 37.8 GHz (point A) and 40.0 GHz (point B).

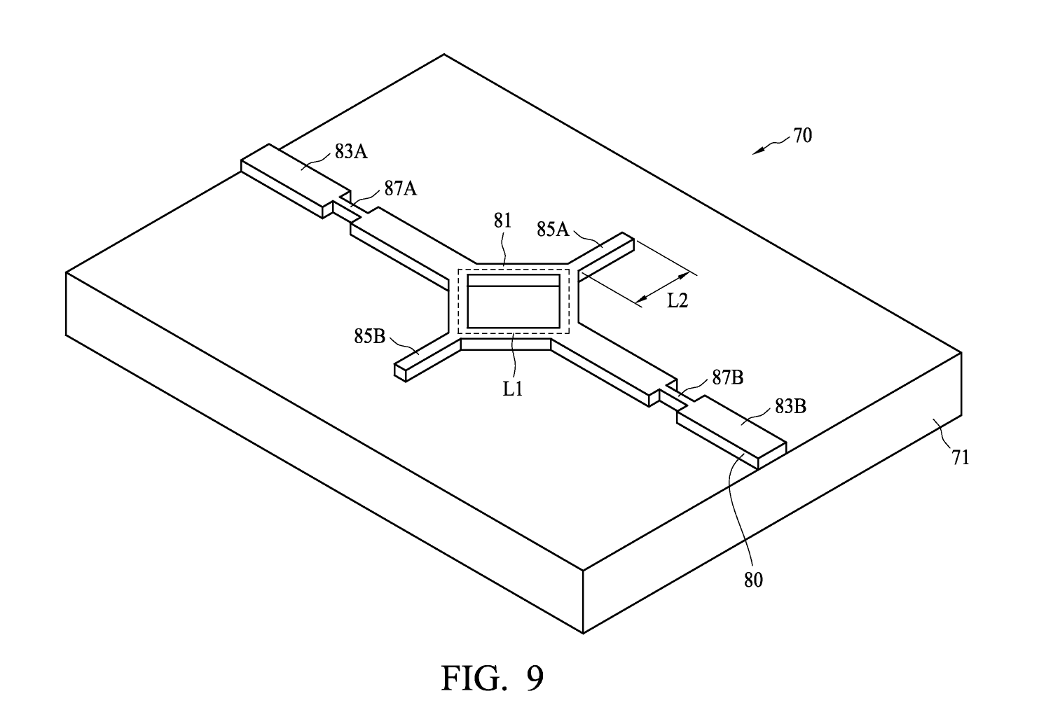

FIG. 9 is a full view of a band-pass filter 70 according to a further embodiment of the present invention. In an exemplary embodiment of the present invention, the band-pass filter 70 comprises a dielectric substrate 71 and a conductive layer 80 disposed over the dielectric substrate 71, wherein the conductive layer 80 comprises a diamond-shaped loop portion 81; a first signal terminal 83A extending from a first side of the loop portion 81; a second signal terminal 83B extending from a second side of the loop portion 81; a first branch 85A extending from a third side of the loop portion 81; and a second branch 85B extending from a fourth side of the loop portion 81.

In one embodiment of the present invention, the second side is substantially opposite to the first side, and the third side and fourth side are substantially perpendicular to the first side. In one embodiment of the present invention, and the first branch 85A is symmetrical to the second branch 85B, and the first branch 85A and the second branch 85B are used for a signal cutoff. In one embodiment of the present invention, the first signal terminal 83A is symmetrical to the second signal terminal 83B, and the first signal terminal 83A and the second signal terminal 83B are used for a signal input and output.

In one embodiment of the present invention, the conductive layer 80 further comprises a first impedance-matching portion 87A connecting the loop portion 81 and the first signal terminal 83A, and a second impedance-matching portion 87B connecting the loop portion 81 and the second signal terminal 83B. In one embodiment of the present invention, the width of the branches 85A and 85B is smaller than the width of the loop portion 81, and the width of the impedance-matching portions 87A and 87B is smaller than the width of the loop portion 81.

In one embodiment of the present invention, the dielectric substrate 71 is an RF-35A2 fiberglass substrate with a dielectric constant of 3.5, and the conductive layer 80 is made of copper. In an exemplary embodiment of the present invention, the characteristic impedance of the signal terminals 83A and 83B is set to a predetermined value; for example, 75 ohms. In an exemplary embodiment of the present invention, the length (L1) of the diamond-shaped loop portion 81 and the length (L2) of the branches 85A and 85B substantially comply with the following formula:

$$L 1 = \frac{C \text{/} {f}_{0}}{\sqrt{{ɛ}_{r}}}$$

$${λ}_{c} = \frac{C \text{/} {f}_{c}}{\sqrt{{ɛ}_{γ}}}$$

$$L 2 = \frac{{λ}_{c}}{4}$$

C represents the velocity of light, f₀ represents a pass band center frequency, f_{c} represents a rejection frequency, λ_{c} represents a rejection band propagation wave length, and εᵣ represents the dielectric constant of the dielectric substrate 71.

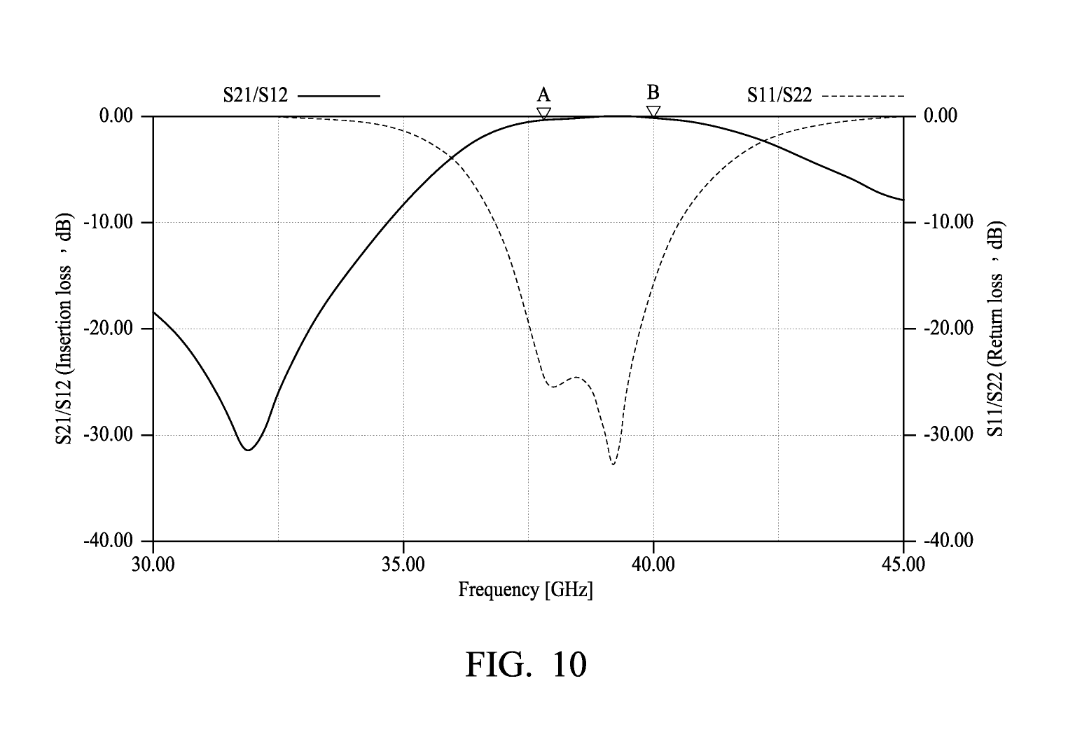

FIG. 10 is a simulated frequency response diagram of the band-pass filter 70, as shown in FIG. 9, in which the transverse axis represents the frequency and the longitudinal axis represents the insertion loss (solid line) or return loss (dash line). As shown in FIG. 10, the pass-band of the band-pass filter 70 is roughly located between 38.8 GHz (point A) and 40.0 GHz (point B).

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A band-pass filter, comprising:
a dielectric substrate and a conductive layer disposed over the dielectric substrate, wherein the conductive layer comprises;
a loop portion;
a first signal terminal extending from a first side of the loop portion;
a second signal terminal extending from a second side of the loop portion;
a first branch extending from a third side of the loop portion; and
a second branch extending from a fourth side of the loop portion.

2. The band-pass filter of claim 1, wherein the loop portion has a first width, and the first branch has a second width smaller than the first width.

3. The band-pass filter of claim 1, wherein the conductive layer further comprises a first impedance-matching portion connecting the loop portion and the first signal terminal.

4. The band-pass filter of claim 3, wherein the loop portion has a first width, and the first impedance-matching portion has a second width smaller than the first width.

5. The band-pass filter of claim 3, wherein the conductive layer further comprises a second impedance-matching portion connecting the loop portion and the second signal terminal.

6. The band-pass filter of claim 1, wherein the third side is substantially perpendicular to the first side.

7. The band-pass filter of claim 1, wherein the second side is substantially opposite to the first side.

8. The band-pass filter of claim 1, wherein the first signal terminal is symmetrical to the second signal terminal.

9. The band-pass filter of claim 1, wherein the first branch is symmetrical to the second branch.

10. The band-pass filter of claim 1, wherein the loop portion is circular, elliptic, rectangular, or diamond-shaped.

11. A band-pass filter, comprising:
a dielectric substrate and a conductive layer disposed over the dielectric substrate, wherein the conductive layer comprises;
a loop portion;
a pair of signal terminals extending from two opposite sides of the loop portion; and
a pair of branches extending from two opposite sides of the loop portion;
wherein the signal terminals and the branches extend from different sides of the loop portion.

12. The band-pass filter of claim 11, wherein the loop portion has a first width, and the branches have a second width smaller than the first width.

13. The band-pass filter of claim 11, wherein the conductive layer further comprises an impedance-matching portion connecting the loop portion and one of the signal terminals.

14. The band-pass filter of claim 13, wherein the loop portion has a first width, and the impedance-matching portion has a second width smaller than the first width.

15. The band-pass filter of claim 11, wherein the signal terminals and the branches extend from the loop portion substantially in a perpendicular manner.

16. The band-pass filter of claim 11, wherein the loop portion is circular, elliptic, rectangular, or diamond-shaped.
